(19) United States
(12) Patent Application Publication
(10) Pub. No.: US 2019/0239191 A1
(43) Pub. Date: Aug. 1, 2019

(54) RADIO ACCESS NETWORK NODE AND A CORE NETWORK NODE FOR PAGING A WIRELESS DEVICE IN A WIRELESS COMMUNICATION NETWORK

(71) Applicant: Telefonaktiebolaget LM Ericsson (publ), Stockholm (SE)

(72) Inventors: Oscar Zee, Stockholm (SE); Angelo Centonza, Stockholm (SE); Paul Schliwa-Bertling, Ljungsbro (SE); Alexander Vesely, Feldbach (AT); Lars-Bertil Olsson, Angered (SE)

(73) Assignee: Telefonaktiebolaget LM Ericsson (publ), Stockholm (SE)

(21) Appl. No.: 16/325,534

(22) PCT Filed: Aug. 18, 2017
(86) PCT No.: PCT/SE2017/050832

§ 371 Date: Feb. 14, 2019

Related U.S. Application Data
(60) Provisional application No. 62/376,954, filed on Aug. 19, 2016.

(51) Int. Cl. H04W 68/04; H04W 68/02; H04W 68/00; H04W 36/00; H04W 76/27

(52) U.S. Cl. CPC H04W 68/04; H04W 68/02; H04W 76/27; H04W 36/0016; H04W 68/005

(57) ABSTRACT

A Radio Access Network, RAN, node, a Core Network, CN, node and respective methods performed thereby are provided for paging a wireless device in a wireless communication network. The method performed by the RAN node comprises exchanging paging strategy information with a CN node, performing a RAN paging procedure of the wireless device according to the exchanged paging strategy information, and updating the paging strategy information based on the outcome of the performed paging procedure.

### TECHNICAL FIELD

The present disclosure relates to wireless communication and in particular to paging a wireless device in a wireless communication network.

### BACKGROUND

The third generation partnership project (3GPP) is currently working on standardisation of Release 13 of the Long Term Evolution (LTE) concept. The architecture of the LTE system is shown in FIG. 3a, including radio access nodes (evolved Node Bs—eNBs, Home eNBs—HeNBs, HeNB GateWay—GW) and evolved packet core nodes (Mobility Management Entity, MME/Serving, S, -GW). As it can be seen an S1 interface connects HeNBs/eNBs to the MME/S-GW and HeNBs to the HeNB GW, while an X2 interface connects peer eNBs/HeNBs, optionally via an X2 GW.

An exemplifying management system possible in this disclosure is shown in FIG. 3b. The node elements (NE), also referred to as eNodeB, are managed by a domain manager (DM), also referred to as the operation and support system (OSS). A Domain Manager (DM) may further be managed by a network manager (NM). Two NEs are interfaced by X2, whereas the interface between two DMs is referred to as Itf-P2P, which stands for Interface P. The management system may configure the network elements, as well as receive observations associated to features in the network elements. For example, DM observes and configures NEs, while NM observes and configures DM, as well as NE via DM.

By means of configuration via the DM, NM and related interfaces, functions over the X2 and S1 interfaces may be carried out in a coordinated way throughout the Radio Access Network (RAN), potentially involving the Core Network, i.e. MME and S-GWs.

The procedure Network triggered Service Request may use paging to establish a signalling connection between a Core Network, CN, and a wireless device, e.g. a User Equipment, UE. Some examples of triggering events to the Network triggered Service Request procedure are signalling for mobile terminating Short Message Service, SMS, downlink user data and downlink Non-Access Stratum, NAS, control signalling.

A wireless device, also referred to as a UE, which is served by a 3GPP network is by a CN registered at a serving area, also known as a registration area. In LTE, the registration area comprises a list of tracking areas, the Non Access Stratum Tracking Area Identity, NAS TAI, List. A purpose with the registration area is to enable a UE in Radio Resource Control, RRC, -IDLE to move and change cell between cells of the tracking areas in the NAS TAI List without any signalling to the CN. When the UE moves to a cell not part of its registration area the UE is required to start the Tracking Area Update, TAU, procedure and request to be registered at the new location, and the UE is assigned with a new registration area.

The CN uses paging to make a wireless device (e.g. a UE) reachable for signalling exchange with the CN. Since the wireless device is known to be camping in its registration area the CN may choose to send paging messages to all cells of the tracking areas that are part of the registration area NAS TAI List. A wireless device with radio connectivity will then be guaranteed response to the paging in the cell where the wireless device is currently camping.

Paging over all cells of the NAS TAI List is, however, normally not used since paging in a large number of cells causes high signalling load both in CN and in RAN.

A realisation of paging performed by an MME may be optimised such that the MME sends a first paging request to the RAN to only cover part of the UE registration area. In case the UE does not respond, the MME repeats the paging request and also makes the paging request cover a larger part of the registration area.

At deciding a paging strategy for the Network triggered Service Request execution, the MME may use additional information to determine with which priority a signalling exchange with the UE is requested. The Network triggered Service Request execution is triggered by e.g. Downlink (user or control) data transmission to a UE which is in IDLE state, see 3GPP 23.401 v13 chapter 5.3.4.2.

It is not yet specified by 3GPP if and how the LTE architecture should evolve to meet the challenges of the 5G time frame.

It may be assumed that there will be evolved counterparts of the S1, X2 and Uu interfaces and that any new Radio Access Technology, RAT, would be integrated with the LTE radio interface at a RAN level in a similar fashion as the way LTE Dual Connectivity is defined.

The overall principles of the methods, schemes and system described in this disclosure would work for both an LTE-like architecture and a new architecture based on an evolution of the S1 interface.

RRC Suspension

In 3GPP technical specification 23.401 chapter 5.3.4A version 13.6.0, there is a description on RRC suspension principle.

In current EPS networks the main contributors to the signalling overhead and load are procedures used for UE state transition, i.e. at transition between the Idle and the connected states.

FIG. 3c illustrates the current S1/EPS architecture based procedures required to establish and tear down a connection in order for the UE to be able to transfer/receive user plane data, i.e. procedures applicable at UE idle/connected state transition. As it can be seen there is a significant signalling overhead on the Uu (radio) and S1 interfaces for small data transactions.

In order to reduce the signalling overhead and the associated processing load in the network SA2 and RAN WGs have introduced a solution in Rel-13 that allows an RRC connection to be suspended and at a later time resumed; minimising the need to go through the full signalling procedure for idle to connected state transition, see e.g. 3GPP 23.401 v13.6.0 chapter 5.3.4A. The solution is applicable both to normal LTE UEs and Internet of Things, IoT, UEs.

The adopted solution is based on enhancements to the IDLE state to make it possible to resume the RRC connection avoiding the need to set it up again when the UE returns from IDLE, assuming that most of the times the UE re-connects to or re-appears in a node which has the stored RRC context. The procedure is illustrated in FIG. 3d.

The following mechanism may be employed for smart paging. For the signalling flow in FIG. 3c, the S1AP message “UE context Release Complete” from the eNB to the MME, an optional Information Element, IE, “Information on Recommended Cells and eNBs for Paging”, is introduced, where eNB provides a Cell Global Identity, CGI, and time stayed for the recommended cells, and global eNB ID/TAI of the recommended eNB. The eNB has an identity or identifier, ID; which uniquely defines the eNB within the wireless communication network in which it is employed. The eNB-ID can have either 20 bits or 28 bits. The eNB-ID is also comprised within the global eNB-ID, which uniquely identifies an eNodeB globally. The Global eNB-ID is constructed from the Mobile Country Code, MCC, Mobile Network Code, MNC, and eNB-ID. For the TAI, see e.g. 3GPP 24.301 v13.5.0 chapter 9.9.3.32. The eNodeB may also include information about recommended cells for paging also in the S1AP signalling performed to indicate a start of suspend. As stated above, in 3GPP technical specification 23.401 chapter 5.3.4A version 13.6.0, there is a description on RRC suspension principle.

In S1AP message “Paging” from MME to eNB, an optional IE, “Assistance Data for Paging” is introduced, where MME provides the CGI and time stayed for the recommended cells, and paging attempt count.

The following mechanism may be employed for RRC connection time handling. In both S1AP messages “Initial Context Setup Request” and “Handover Request” from MME to eNB, an optional IE, “Expected UE Behaviour” is introduced, where MME provides information on expected activity period, idle period and handover interval on the UE.

### SUMMARY

The object is to further improve the paging procedure of a wireless device. In particular, it is an object to provide a Radio Access Network, RAN, node, a Core Network, CN, node and respective methods performed thereby for paging a wireless device in a wireless communication network. These objects and others may be obtained by providing a RAN node, a CN node and a method in a RAN node, an in a CN node according to the independent claims attached below.

According to an aspect, a method performed by a RAN node for paging a wireless device in a wireless communication network is provided. The method comprises exchanging paging strategy information with a CN node; performing a RAN paging procedure of the wireless device according to the exchanged paging strategy information; and updating the paging strategy information based on the outcome of the performed paging procedure.

According to an aspect, a method performed by a CN node for paging a wireless device in a wireless communication network is provided. The method comprises exchanging paging strategy information with a RAN node; receiving a request from the RAN node for paging the wireless device; and performing the paging of the wireless device according to the received request.

According to an aspect, a RAN node for paging a wireless device in a wireless communication network is provided. The RAN node is configured for exchanging paging strategy information with a CN node; performing a RAN paging procedure of the wireless device according to the exchanged paging strategy information; and updating the paging strategy information based on the outcome of the performed paging procedure.

According to an aspect, a CN node for paging a wireless device in a wireless communication network is provided. The CN node is configured for exchanging paging strategy information with a RAN node; receiving a request from the RAN node for paging the wireless device; and performing the paging of the wireless device according to the received request.

The method performed by the RAN node, the method performed by the CN node, the RAN node and the CN node have several advantages. One possible advantage is that the wireless device may be paged minimising usage of paging resources and/or radio resource usage. Another possible advantage is that the wireless device may need to listen continuously to the same paging intervals only, independently of whether paging is triggered by a RAN node or a CN node. By aligning paging strategies, the wireless device does not have to be configured differently depending on the whether the CN node or the RAN node is performing paging; which in turn reduces signalling load towards the wireless device.

### BRIEF DESCRIPTION OF DRAWINGS

Embodiments will now be described in more detail in relation to the accompanying drawings, in which:

FIG. 1a is a flowchart of a method performed by a RAN node for paging a wireless device in a wireless communication network, according to an exemplifying embodiment.

FIG. 1b is a flowchart of a method performed by a RAN node for paging a wireless device in a wireless communication network, according to yet an exemplifying embodiment.

FIG. 1c is a flowchart of a method performed by a RAN node for paging a wireless device in a wireless communication network, according to still an exemplifying embodiment.

FIG. 1d is a flowchart of a method performed by a RAN node for paging a wireless device in a wireless communication network, according to another exemplifying embodiment.

FIG. 2a is a flowchart of a method performed by a CN node for paging a wireless device in a wireless communication network, according to an exemplifying embodiment.

FIG. 2b is a flowchart of a method performed by a CN node for paging a wireless device in a wireless communication network according to yet, an exemplifying embodiment.

FIG. 2c is a flowchart of a method performed by a CN node for paging a wireless device in a wireless communication network, according to still an exemplifying embodiment.

FIG. 3a is an illustration of an LTE architecture illustrating logical interfaces between eNBs and HeNBs (X2) and between eNB/HeNBs and MME/S-GW (S1).

FIG. 3b is an illustration of a management system architecture example.

FIG. 3c is a signalling diagram of a legacy connection setup and release procedure.

FIG. 3d is a signalling diagram of a procedure for resumption of a previously suspended RRC connection.

FIG. 4 is a block diagram of a RAN node for paging a wireless device in a wireless communication network according to an exemplifying embodiment.

FIG. 5 is a block diagram of a RAN node for paging a wireless device in a wireless communication network according to yet an exemplifying embodiment.

FIG. 6 is a block diagram of a CN node for paging a wireless device in a wireless communication network according to an exemplifying embodiment.

FIG. 7 is a block diagram of a CN node for paging a wireless device in a wireless communication network according to still an exemplifying embodiment.

FIG. 8 is a block diagram of an arrangement in a RAN node for paging a wireless device in a wireless communication network according to an exemplifying embodiment.

FIG. 9 is a block diagram of an arrangement in a CN node for paging a wireless device in a wireless communication network according to an exemplifying embodiment.

### DETAILED DESCRIPTION

An object of the present disclosure is to provide methods for enabling efficient and reliable paging in a wireless communication network. Another object of one or more optional embodiments described in the present disclosure is to provide methods for enabling a selection of a proper RAN paging strategy fulfilling paging latency requirements and characteristics.

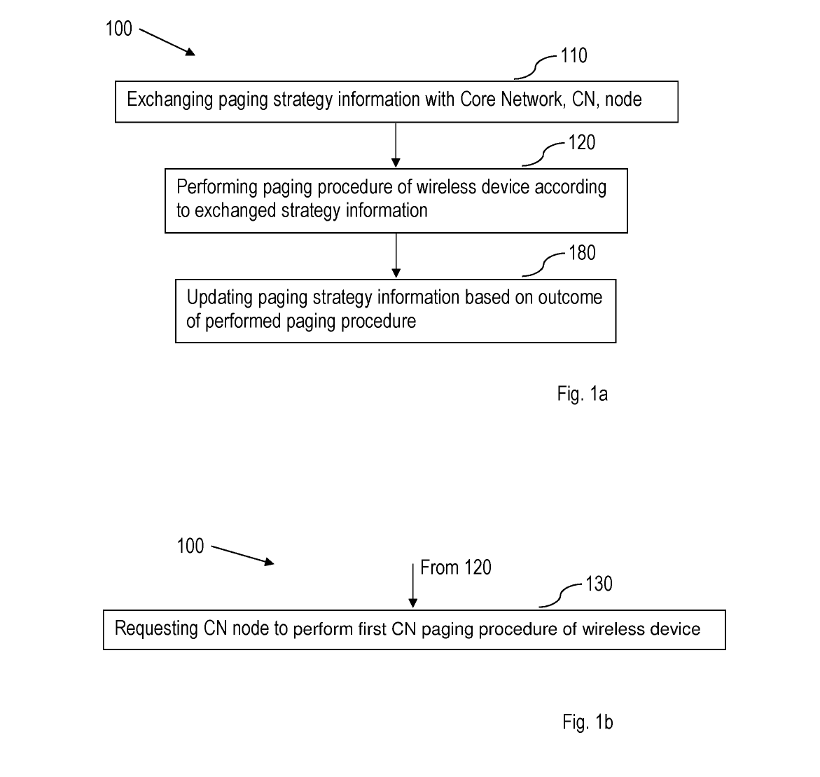

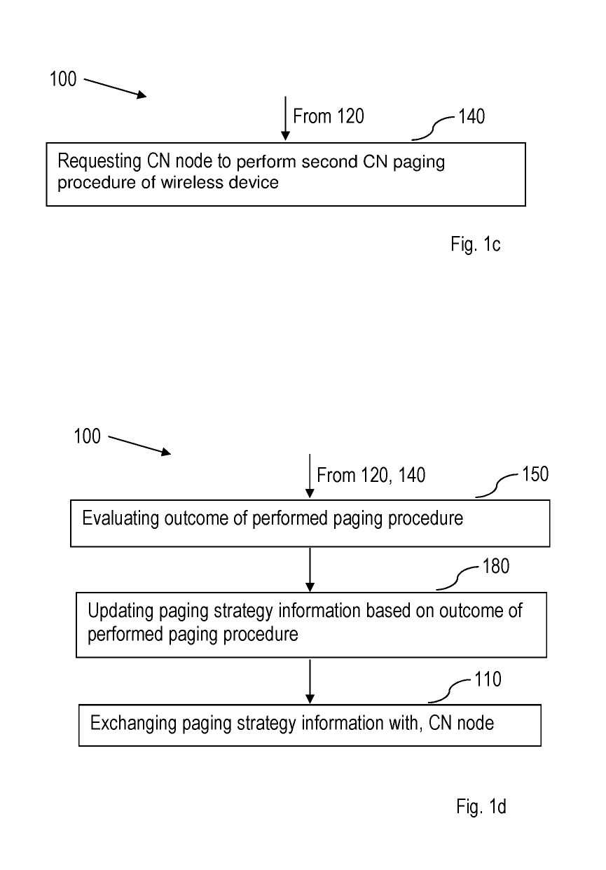

Embodiments herein relate to a method performed by a Radio Access Network, RAN, node for paging a wireless device in a wireless communication network. Different embodiments and examples of such a method will now be described with reference to FIGS. 1a-1d.

FIG. 1a illustrates the method 100 comprising exchanging 110 paging strategy information with a Core Network, CN, node, performing 120 a RAN paging procedure of the wireless device according to the exchanged paging strategy information; and updating 180 the paging strategy information based on the outcome of the performed paging procedure.

The paging strategy may comprise various different information, aspects, components and/or characteristics. Merely as a non-limiting example (a), the paging strategy may comprise a per service information about urgency or priority of the service for which the paging is initiated. In an example, such information may be expressed as an acceptable maximum delay from start of paging signalling (RAN paging procedure) until the RAN node needs to abandon the RAN paging procedure for the case that there is no response from the wireless device. Such information may be indicated individually per user data flow to enable the RAN node to apply different paging logic/scheme depending on to which service the user data is associated with. In RANs of legacy communication systems, e.g. legacy E_UTRA, this could be per EPS bearer/E-RAB (Radio Access Bearer).

According to another non-limiting example (b), the paging strategy may comprise the paging area in which the RAN node is expected to perform paging, or the time order of different paging area, which the RAN node is expected to perform paging, based on the probability of where the UE is located, based on historical mobility data.

Combining the two examples of (a) an acceptable maximum delay together with (b) a paging area may enable the RAN node to apply its own paging logic, for example start by paging in last visited cell and only at no response, widening the scope and page in additional cell.

A possible benefit is that usage of paging resources may be minimised while still fulfilling e.g. delay requirement as expressed by a).

The paging strategy information provides the RAN node with information on how to perform the RAN paging procedure to successfully reach the wireless device while minimising usage of paging resources and/or radio resource usage.

The RAN node may then perform the RAN paging procedure according to the paging strategy information. The RAN paging procedure may result in a response from the wireless device or failure to receive a response from the wireless device.

The paging strategy may prove successful, adequate or unsuccessful. Depending on the outcome of the performed paging procedure, the RAN node may update the paging strategy information based thereon.

The method performed by the RAN node may have several advantages. One possible advantage is that the wireless device may be paged minimising usage of paging resources and/or radio resource usage. Another possible advantage is that the wireless device may only need to always listen to the same paging intervals, independently of whether paging is triggered by a RAN node or a CN node. By aligning patent strategies, the wireless device does not have to be configured differently depending on whether the CN node or the RAN node is performing paging; which in turn reduces signalling load towards the wireless device.

The updating 180 of the paging strategy information may comprise receiving the updated paging strategy information from the CN node.

The updating 180 of the paging strategy information may comprise evaluating 150 the outcome of the performed paging procedure.

As will be explained in more detail below, the paging strategy information may be evaluated by the RAN node and/or the CN node.

As described above, the RAN node may exchange paging strategy information with the CN node. There are various ways of doing so as described above. For example, the paging strategy information may be exchanged by one or more information elements in a message of an Evolved Radio Access Bearer, E-RAB, management procedure, and/or by one or more information elements in a message of a User Equipment, UE, context management procedure; and/or control signalling between the RAN node and the CN node.

When the outcome of the performed RAN paging procedure is (a) failure to reach the wireless device, or (b) failure to reach the wireless device within a predefined timeframe or, (c) failure due to other reasons determined by the RAN node, or (d) when the RAN node determines to do so for other reasons, the method 100 may comprises sending a request 130 to the CN node to perform a first CN paging procedure of the wireless device. This is illustrated in FIG. 1b.

The first CN paging procedure may entail the CN node taking over the responsibility for paging the wireless device, wherein the first paging procedure comprises a paging strategy for the CN node. There may be different reasons for the RAN node to fail its paging procedure to the wireless device. For example, urgency to reach the wireless device so that the wireless device was not reached in time, i.e. in other words due to latency requirement for the transmitted data to reach the wireless device or QoS requirement for the bearer on the paged wireless device. If the latency requirements or QoS requirements are strict, the RAN node may immediate request the CN for a first paging over air.

Sending the request 130 to the CN node to perform the first CN paging procedure of the wireless device comprises providing the CN node with information pertaining to the performed RAN paging procedure.

Since the RAN node already may have performed parts of its paging procedure, at least in the case that the RAN paging procedure has failed, it may be that e.g. paging signalling has been transmitted in some cell(s) and/or that time for the duration of the RAN paging procedure has lapsed. The RAN node may thus provide information to the CN node so that the CN node is informed of what has happened so far so that the CN node may adapt its first CN paging procedure accordingly.

When the outcome of the performed RAN paging procedure is (a) failure to reach the wireless device, or (b) failure to reach the wireless device within a predefined timeframe or, (c) failure due to other reasons determined by the RAN node, or (d) when the RAN node determines to do so for other reasons, the method 100 comprises sending a request 140 to the CN node to perform a second CN paging procedure.

In this exemplifying embodiment, the RAN node may still keep responsibility for paging the wireless device. The second CN paging procedure may entail e.g. the CN node paging the wireless device in areas the RAN node does not page by means of the RAN paging. The second CN paging procedure may also or alternatively entail the CN node paging the wireless device in areas the RAN node cannot or do not want to reach.

The RAN node may also provide the CN node with information pertaining to the possibly performed RAN paging procedure when sending the request 140 to the CN node to perform the second CN paging procedure. Such information may be incorporated in the request or may be transmitted in additional messaging or signalling.

The method 100 may further comprise evaluating 150 the outcome of the performed RAN paging procedure, updating 180 the paging strategy information based on the evaluated outcome and exchanging 110 paging strategy information with the CN node. In this example, when the RAN node sends the request 140 to the CN node to perform the second CN paging procedure, the second CN procedure may be seen as a part of the RAN paging procedure since the RAN node does not completely request the CN node to take over the paging responsibility, but rather provide some additional help in paging the wireless device.

As described above, either the RAN node or the CN node may update the paging strategy information based on the evaluated outcome of the paging of the wireless device. The evaluation may be with regards to e.g. (i) time used for the paging procedure, (ii) paging is successful/failed, (iii) the cell identity where the wireless device response to the paging message. The evaluation may be done together with previous information like cell ID where the wireless device enters dormant state, timing requirement of the flow/bearers etc., time between when the wireless device entered dormant state until the wireless device is being paged etc. In one example, it is the RAN node that evaluates the outcome of the performed paging procedure, which may comprise the part of the second CN paging procedure. Once the paging strategy information is updated, the RAN node exchanges the updated paging strategy information with the CN node so that both nodes have the most up-to-date paging strategy information.

In an illustrative example, the evaluating of the outcome of the performed paging procedure may comprise determining whether a paging delay is within a predefined time interval.

There are other ways to evaluate the paging procedure with regards to other parameters. Non-limiting examples of such parameters are movement of the wireless device (where the paging response has been received, and the time between the wireless device is set to dormant state until the paging is being performed), Quality of Service of the wireless device (different services have different time requirement).

The evaluation may be performed by comparing a parameter to a respective threshold, to a respective interval for the parameter etc. The parameter could be any of the parameters that is described just above. An over-simplified example, for illustrative purposes only, could be to first compare the time between the wireless device enters dormant state and the wireless device is paged by RAN using RAN paging with a table with different time intervals, and then check the movement of the device (static or non-static). If now the wireless device has long time interval between switch-to-dormant/paging-occasion and the device is static (meaning no movement), then the paging strategy could be changed to a more narrow initial paging area, for both RAN paging and CN paging. This strategy needs to propagate to CN as CN is not aware of this paging results as RAN is taking care of the paging completely.

Embodiments herein also relate to a method 200 performed by a Core Network, CN, node for paging a wireless device in a wireless communication network.

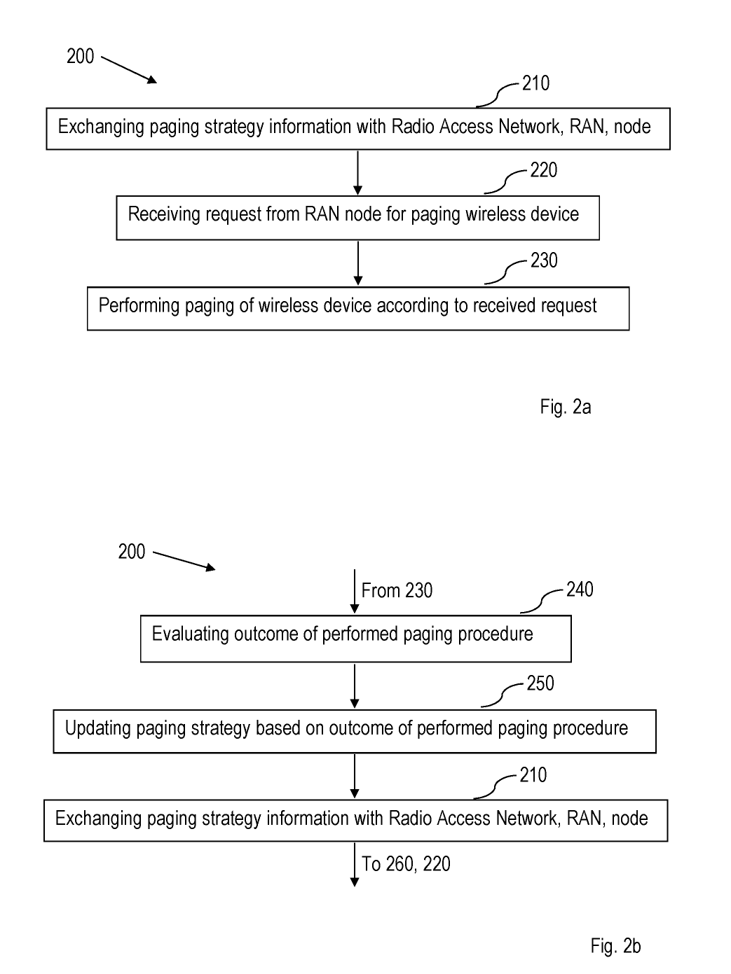

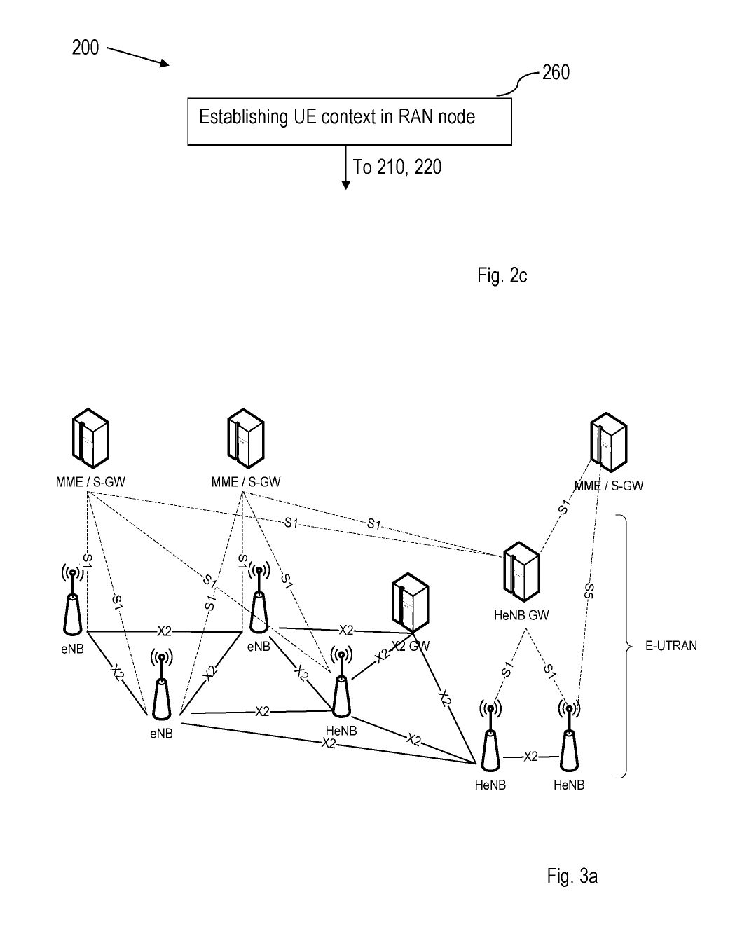

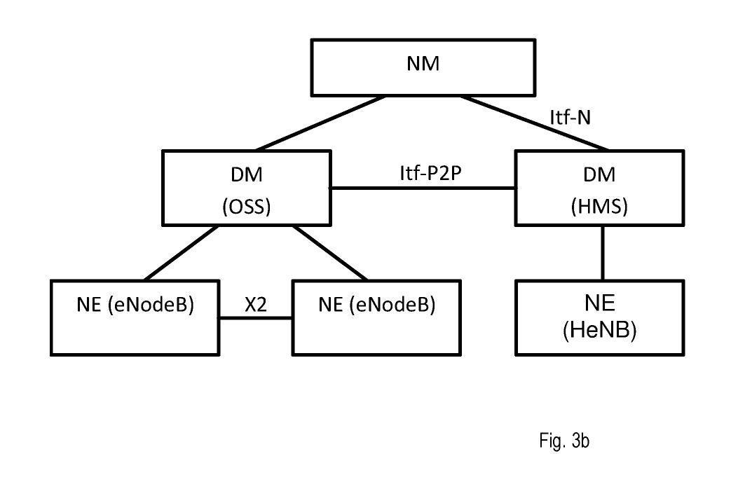

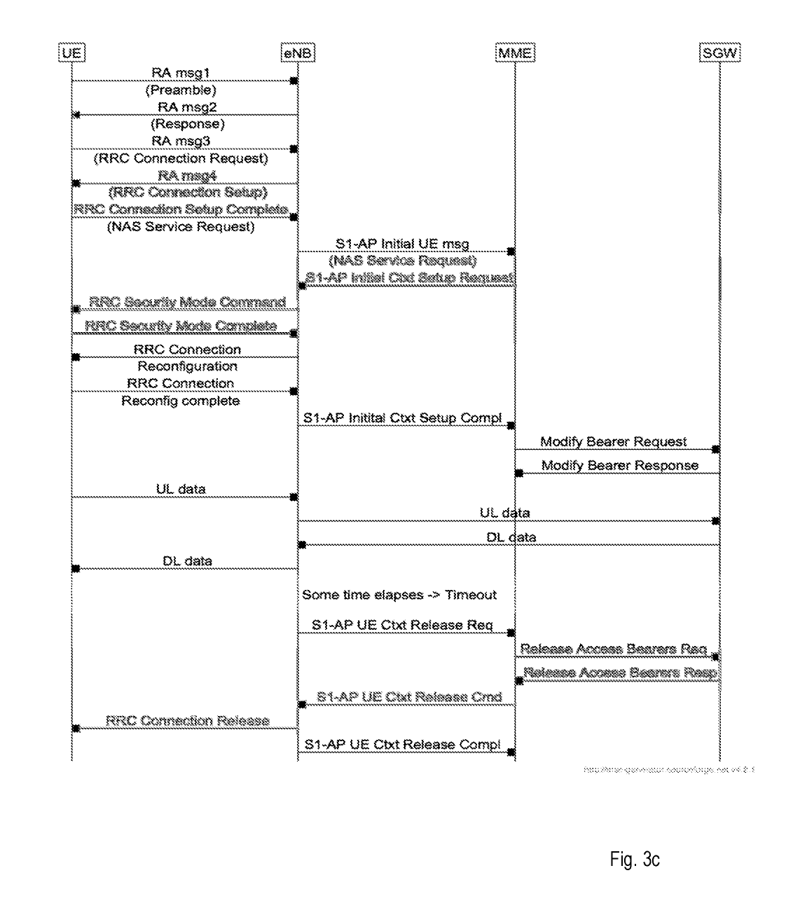

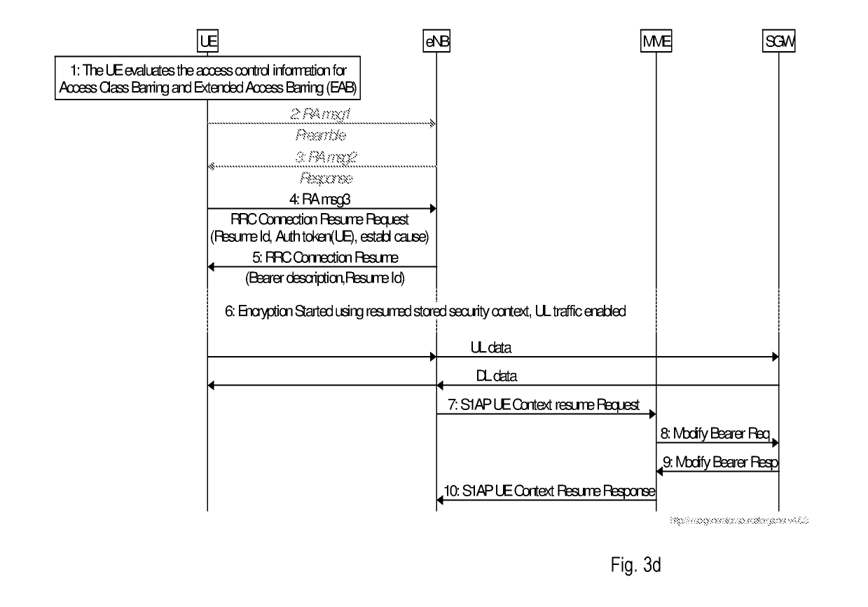

Embodiments of such a method will now be described with reference to FIGS. 2a-2c. FIG. 2a illustrates the method comprising exchanging 210 paging strategy information with a Radio Access Network, RAN, node; receiving 220 a request from the RAN node for paging the wireless device; and performing 230 the paging of the wireless device according to the received request.

As described above, the RAN node and CN node may exchange the paging strategy information so that both are up-to-date with the most current version in case it may have changed. It may be the CN node transmitting the paging strategy information to the RAN node or the RAN node transmitting the paging strategy information to the CN node.

The CN node may receive the request from the RAN node for paging the wireless device. The request may comprise the first CN paging procedure or the second CN paging procedure, wherein the CN node is informed of what type of request it receives from the RAN node. The CN node is then also informed as to how to act upon reception of the request, see the description above for the definition of the first and the second CN paging procedures.

The CN node may then perform the paging of the wireless device according to the received request.

The method performed by the CN node has the same advantages as the method performed by the RAN node. One possible advantage is that the wireless device may be paged minimising usage of paging resources and/or radio resource usage. Another possible advantage is that the wireless device may only need to listen always to the same paging intervals, independently of whether paging is triggered by a RAN node or a CN node. On the contrary, if the RAN node and the CN node were not aligned on paging strategies the wireless device would need to be configured differently depending on whether the CN node or the RAN node is performing paging, which would imply higher signalling load towards the wireless device and potential issues with temporary stale wireless device configuration regarding paging periods.

The received request from the RAN node for paging the wireless device may request the CN node to take over the paging procedure from the RAN node, the performing 230 of the paging procedure comprises applying the paging strategy information to the paging procedure and optionally information comprised in the received request from the RAN node.

In this example, the request comprises the first CN paging procedure described above.

When the outcome of the performed first CN paging procedure is successful in reaching the wireless device, the method 200 may further comprise evaluating 240 the outcome of the performed paging procedure, updating 250 the paging strategy information based on the evaluated outcome and exchanging 210 paging strategy information with the RAN node.

Also as described above, the CN node may evaluate the outcome of the performed paging procedure. The evaluation may be performed in the same manner as described above, e.g. by comparing a parameter to a respective threshold value, interval etc. associated with the parameter.

The received request from the RAN node for paging the wireless device requests the CN node to perform a paging attempt may comprise information enabling the CN node to perform the requested paging attempt, the performing 230 of the paging of the wireless device is performed according to the received request and in view of the information comprised in the received request from the RAN node.

This corresponds to the received request from the RAN node comprising the second CN paging procedure as described above.

When the outcome of the performed second CN paging procedure is successful in reaching the wireless device, the method 200 may further comprise evaluating 240 the outcome of the performed paging procedure, updating 250 the paging strategy information based on the evaluated outcome and exchanging 210 paging strategy information with the RAN node.

The method 200 may further comprise establishing 260 a UE context in a RAN node.

The RAN node in which the UE context is established may be the same RAN node described above that started the RAN paging procedure or another RAN node.

There may be a latency requirement on a time interval between the point in time when paging is triggered by DL data arrival, and the point in time when a paging request is responded to by the UE and the DL data is received by the wireless device, e.g. a UE. Hereinafter, the wireless device will be referred to as the UE. In order to fulfil the requirement, RAN and CN may use the following parameters as input:
Historical information about registered mobility of the UE
Data activity and idle period of the UE
Service Requirement for the UE (e.g. Quality-of-Service, QoS, details such as the Packet Delay Budget associated with a specific QCI value)
The elapsed time of the current paging
Paging area information for UE (e.g. TAI list)
The area which has been paged so far

The paging strategy, i.e. the order, duration and propagation of the paging mechanism mentioned in previous chapter needs to be adjusted accordingly based on the above inputs.

As RAN paging is introduced, the responsibility of paging may partly be moved from Core Network to RAN. In order to be able to execute a paging strategy by RAN, there is a need of information exchange between eNB and MME prior to and during paging occasion. The information which is already available today is not sufficient for this execution with the following reasons:
(1) When DL data arrives to eNB for a UE in dormant state, eNB has the following information
   a. “Expected UE Behaviour” from “Initial Context Setup Request” or “Handover Request” on expected activity period, idle period and handover interval on the UE. This information can be retrieved via explicit signalling from the MME, however even without such signalling the eNB is able to keep track of UE behaviour, i.e. idle-active transition times and other statistics by virtue of maintaining a UE context that stores these information
   b. Time where the UE has been in dormant state, captured by the eNB.
The eNB still does not have paging area information or information on service requirements for services used by the UE. In prior art, when the MME is deciding the paging strategy, it will use (1) a and b as input together with paging area information and QoS requirement of the service. And now when RAN paging is performed in eNB, eNB needs to have same information as MME for making the same decision.
The paging area information can be used in a case when an eNB (and its neighbours) serves multiple tracking areas. If the eNB receives paging area information for the UE from the Core Network, the RAN paging may then be optimised by transmitting paging messages only on those cells which are part of the paging area, i.e. avoid paging in cells in tracking areas that are not part of the paging area. Access to information about the paging area may also enable the eNB (which is an example of a RAN node) to determine when to stop paging.
Information about application service requirements may, for example, imply that a UE may need to be paged in a frequent way and with an immediate wide paging scope to achieve low delays from when data is available at the CN until such data can be sent to the UE. An example service where this is required is IMS and paging caused by a Mobile Terminated (MT) call. With access to service or bearer specific information it is possible to optimize RAN paging strategies.
(2) When the eNB transmits “paging assistance request” to the MME, the MME needs to have the parameter input mentioned above for executing a paging strategy.
(2) is valid during RAN paging, after the eNB fails to page the UE and needs assistance of the MME (CN). As the CN has no information on what happened during the RAN paging procedure, the CN will need some updates on this history (and in some cases also the information in (1) for performing the optimised paging procedure.

Different embodiments providing a possibility to fulfil the paging strategy when RAN paging is introduced.

In a first exemplifying embodiment, the MME informs eNB about CN reachability requirements for the UE, i.e. how long time the UE needs to be reached vs how big the area should be paged for each iteration of paging, and also provides eNB with additional information on service requirement and paging area. This may be done in various different ways.

A first example of the first exemplifying embodiment is applicable for service requirement information. The first example entails introducing additional information element on data latency of the UE bearers for eNB during Radio Access Bearer-RAB/flow setup in order to decide which RAN paging strategy should be used for fulfilling the characteristics requirement. In other words, during RAB setup procedure, an information element, IE, for transmission latency requirement on each bearer is added, so that the eNB knows the strategy of how the UE should be paged in order to fulfil the transmission latency requirement, as paging may be triggered by incoming DownLink, DL, data and it needs to be delivered in time, where the time is equal to paging time plus data transmission time after the UE is paged.

A second example of the first exemplifying embodiment is applicable for both application service requirement information and paging area information. The MME provides service requirement information and paging area information for each UE during Initial Context Setup, in order to inform the eNB about a wanted paging strategy, together with “expected UE Behaviour” IE. Further the RAN node and the MME may exchange paging strategies in case they change dynamically or to initialise a synchronised setting of the paging procedure. In other words, during Initial context setup procedure, an IE for transmission latency requirement on the UE, and the entities of the paging area (TAI list) is added, so that the eNB knows the strategy of how and where the UE should be paged in order to fulfil the transmission latency requirement, as paging may be triggered by incoming DL data and it needs to be delivered in time, where the time is equal to paging time plus data transmission time after the UE is paged. If now the eNB changes the strategy of that UE due to additional information (e.g. new type or pattern of movement of the UE within the same RAN paging area detected by the RAN in connection with RAN paging), then the new paging strategy needs to be synchronised between the eNB and the MME. This applies also when the MME wants to change the paging strategy.

A third example of the first exemplifying embodiment comprises control signalling between MME and the RAN node, i.e. explicit signalling instead of using the existing signalling procedures to exchange paging strategy information.

In a second exemplifying embodiment, the eNB informs the MME about the paging status when the eNB uses a “paging assistance request” to make the CN perform paging. At a use of “paging assistance request” with the MME, the eNB informs the MME about the progress so far of the RAN paging. Together with supporting information from eNB enables CN to continue with the paging using a wanted/requested paging strategy. This may be done in various different ways.

A first example of the second exemplifying embodiment is that the RAN continues to execute the paging strategy. In this case RAN uses a “paging assistance request” to request the CN to perform a single paging signalling attempt as instructed by the RAN.

A second example of the second exemplifying embodiment is that the RAN moves the paging strategy execution to the CN. In this case the RAN uses a “paging assistance request” to inform the CN that the RAN has concluded paging without reaching the UE. As part of the “paging assistance request” RAN provides CN with detailed information from the paging performed by RAN so far.

In the first exemplifying embodiment above, the RAN and the CN exchange information about paging strategies, e.g. about paging occasions, paging periods, the maximum delay of RAN paging before transfer to CN etc. via the RAN/CN interface. As will be exemplified, the paging strategy, also called paging strategy information may comprise additional and/or other information/parameters/characteristics. The exchange of paging strategies may comprise the CN (e.g. a node in the CN) informing the RAN (e.g. a node in the RAN) about the paging strategies; or the other way around.

In an example of the first exemplifying embodiment, this information may be exchanged via E-RAB management procedures. Possible candidate S1AP messages for such exchange of information may be the E-RAB SETUP REQUEST, the E-RAB SETUP RESPONSE, the E-RAB MODIFY REQUEST, the E-RAB MODIFY RESPONSE, the E-RAB RELEASE COMMAND, the E-RAB RELEASE RESPONSE, the E-RAB RELEASE INDICATION, the E-RAB MODIFICATION INDICATION and the E-RAB MODIFICATION CONFIRM already defined in LTE.

In another example of the second example of the first exemplifying embodiment, this information may be exchanged via UE context management procedures. Possible candidate S1AP messages for such exchange of information may be the INITIAL CONTEXT SETUP REQUEST, the INITIAL CONTEXT SETUP RESPONSE, the UE CONTEXT MODIFICATION INDICATION, the UE CONTEXT MODIFICATION CONFIRM, the UE CONTEXT MODIFICATION REQUEST, the UE CONTEXT MODIFICATION RESPONSE, the HANDOVER REQUIRED, the UE CONTEXT SUSPEND REQUEST, the UE CONTEXT SUSPEND RESPONSE, the UE CONTEXT RESUME REQUEST, the UE CONTEXT RESUME RESPONSE, and the HANDOVER REQUEST already defined in LTE.

In still another example of the first exemplifying embodiment, this information is exchanged by means of other signalling between the CN and the RAN. The signalling may be dedicated for the purpose of exchanging the information or may be incorporated (piggy-backed) in signalling for other purposes.

The embodiment for the above examples is valid for equivalent procedures that may be enabled in other systems such as 5G systems, Next Generation systems and similar.

The CN may as part of an S1AP message include new information elements (IE) for exchanging paging strategy information that specify what is the paging frequency, paging offset with respect to a common time reference, paging repetition information (i.e. CN suggesting how often the UE should be paged), and a requested maximum time for RAN to spend on paging until a connection with the UE is established. Parts of such information would reach the RAN node, e.g. an eNB in the same way as by means of the CN triggered PAGING message, other parts include information with which the RAN node is able to independently page the UE as per paging strategy described by the CN and when the RAN node has concluded the paging without receiving any paging response from the UE, the RAN node may use “paging assistance request” to request the CN to perform paging of the UE.

The CN may also as part of S1AP message include new information element that specifies the paging area information (e.g. TAI list). For this information RAN may avoid transmitting RAN paging message on cells in tracking area which are not in the paging area, for both RAN paging within the eNB node which receives the S1Ap message, or neighbours to this eNB node when X2 related RAN paging applies.

Equivalently, if the RAN updates its paging strategy for example by using a new paging period or paging offset, the RAN may inform the CN about such change by including in a signalling message the new paging strategy information. Such signalling message may be the S1: Initial Context Setup Response or any equivalent message in other radio systems. Alternatively this signalling may occur via a newly defined procedure.

Regarding the exemplified second embodiment, the RAN and the CN exchange information about paging strategies, e.g. about paging occasions, paging periods, the maximum delay of RAN paging before transfer to CN etc., via the RAN/CN interface.

In one example this information may be exchanged via E-RAB management procedures. Possible candidate S1AP messages for such exchange of information are exemplified above.

In another example this information may be exchanged via UE context management procedures. Possible candidate S1AP messages for such exchange of information are exemplified above.

The embodiment for both examples is valid for equivalent procedures that may be enabled in other systems such as 5G systems, Next Generation systems and similar.

The CN may as part of an S1AP message include new information elements that specify what is the paging frequency, paging offset with respect to a common time reference, paging repetition information (i.e. CN suggesting how often the UE should be paged), and a requested maximum time for RAN to spend on paging until a connection with the UE is established. Parts of such information would reach the RAN node, e.g. an eNB in the same way as by means of the CN triggered PAGING message, other parts include information with which the RAN node is able to independently page the UE as per paging strategy described by the CN and when the RAN node has concluded the paging without receiving any paging response from the UE, the RAN node may use “paging assistance request” to request the CN to perform paging of the UE.

The CN may (only valid for the second example above) also as part of S1AP message include new information element that specifies the paging area information (e.g. TAI list). For this information RAN may avoid transmitting RAN paging message on cells in tracking area which are not in the paging area, for both RAN paging within the eNB node which receives the S1AP message, or neighbours to this eNB node when X2 related RAN paging applies.

Equivalently, if the RAN updates its paging strategy for example by using a new paging period or paging offset, the RAN may inform the CN about such change by including in a signalling message the new paging strategy information. Such signalling message may be the S1: Initial Context Setup Response or any equivalent message in other radio systems. Alternatively this signalling may occur via a newly defined procedure.

In the mentioned exemplifying second embodiment, if there is no paging response from the UE to the RAN paging, eNB will ask CN for assistance on paging. In this case RAN should provide information on the progress reached so far with the RAN paging, including information on RAN paging duration, the area information on RAN paging etc. This enhancement is beneficial because it allows the CN to optimise the way paging is performed. This enhancement carries a higher complexity in terms of additional signalling and processing on both CN and RAN sides, however it ensures that the CN may page on paging occasions and strategies for which the UE is optimally configured rather than selecting paging strategy e.g. page on less frequent occasions than the UE is listening to. The latter is a sub optimal process given that the UE is listening periodically to paging and investing battery power to run such process. The sequence may be as followed:
A precondition to the scenario may be that CN has determined that paging of a certain UE may be handled by RAN, i.e. that the UE is suitable to be handled as RRC CONNECTED INACTIVE by RAN while the UE is handled as ECM-CONNECTED by CN.
1. DL user data arrives to core.
2. CN pass the DL user data to RAN.
3. Since UE is not RRC CONNECTED, RAN need to first reach the UE with paging.
4. RAN executes its paging strategy but fails to reach the UE.

Below follow two different examples, the first when the RAN (e.g. a node in RAN) requests the CN to take over the paging; and a second when the RAN maintains responsibility for paging but also requests CN to perform paging in certain areas.

### First Example

5.1 RAN Stops Paging
6.1 RAN Requests CN to Completely Take Over the Paging Mechanism. As part of the signalling for “paging assistance request” RAN may include all or some information about how long time RAN has spent on paging, paging strategy including for example paging occasions, reason for paging (i.e. QoS of the DL user data which triggered RAN to start paging), and the area which RAN has performed paging to reach the UE.
7.1 CN applies its paging strategy and decides which RAN nodes to page, paging interval, which paging repetition to apply, areas already paged, etc. In this case the CN may also page in areas the requesting RAN node had already paged.
8.1 CN succeeds in reaching the UE with paging.
9.1 CN evaluates the paging delay outcome. CN decides if the UE can be handled in state RRC CONNECTED INACTIVE (which means that RAN will do the paging), or, if core shall do all paging in the future, and perform change of paging strategy according to the first embodiment in this IvD.
10.1 CN concludes the state change to ECM-CONNECTED by establishing a UE context in RAN. As part of the UE related information sent to RAN the MME informs RAN about if the UE is eligible to be handled by RRC state RRC CONNECTED INACTIVE or not.

### Second Example

5.2 RAN decides to maintain responsibility for paging strategy but also to request CN to perform paging in areas the RAN either cannot or do not want to reach by means of RAN paging.
6.2 RAN performs signalling for “paging assistance request” (referred to below as a second CN paging procedure) and provides information to the CN for a single paging attempt and provides information which enables CN to do so: paging interval, how long time, and the area which RAN still will page at the next attempt. The RAN may also provide information on how many attempts RAN has spent on paging. The RAN may also request the CN to page in a specific area, for example an area not yet reached by RAN paging, or RAN may request CN to decide the paging area to page in. The RAN node may provide a list of areas in which RAN has already performed paging in order to enable CN to avoid paging in areas already paged by RAN. CN use information about already paged areas for the case when CN decides the paging area.
7.2 The CN performs a single paging attempt to the decided paging area while using the information from the requesting RAN node (including, most prominently, the paging repetition information) on the paging scope of this very paging attempt.
8.2 The single paging performed by CN succeeds in reaching the UE, the UE responds and a connection is established.
9.2 CN or RAN evaluates the paging delay outcome. CN or RAN decides if the UE can be handled in state RRC CONNECTED INACTIVE (which means that RAN will do the paging), or, if core shall do all paging in the future, and perform change of paging strategy according to the first embodiment in this disclosure.
10.2 CN concludes the state change to ECM-CONNECTED by establishing a UE context in RAN. As part of the UE related information sent to RAN the MME informs RAN about if the UE is eligible to be handled by RRC state RRC CONNECTED INACTIVE or not.

In both cases, the paging executed by the CN will have access to information provided by RAN. One of the advantages of this method is that the UE will need to listen always to the same paging intervals, independently of whether paging is triggered by a RAN or CN. On the contrary, if the RAN and CN were not aligned on paging strategies the UE would need to be configured differently depending on whether the CN node or the RAN node is performing paging, which would imply higher signalling load towards the UE and potential issues with temporary stale UE configuration regarding paging periods.

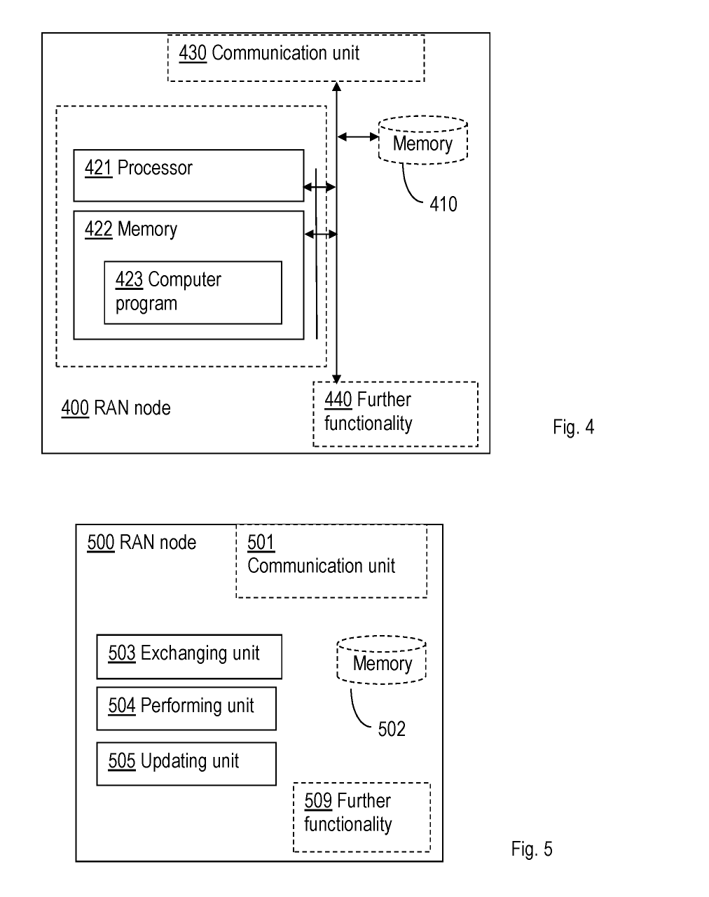

Embodiments herein also relate to a RAN node for paging a wireless device in a wireless communication network. Different embodiments and examples of such a RAN node will now be described with reference to FIGS. 4 and 5.

FIGS. 4 and 5 illustrate the RAN node being configured for exchanging paging strategy information with a Core Network, CN, node, performing a RAN paging procedure of the wireless device according to the exchanged paging strategy information; and updating the paging strategy information based on the outcome of the performed paging procedure.

The RAN node may be implemented or realised in different ways. A first exemplifying implementation or realisation is illustrated in FIG. 4. FIG. 4 illustrates the RAN node 400 comprising a processor 421 and memory 422, the memory comprising instructions, e.g. by means of a computer program 423, which when executed by the processor 421 causes the RAN node 400 to exchange paging strategy information with a CN node, to perform a RAN paging procedure of the wireless device according to the exchanged paging strategy information and to update the paging strategy information based on the outcome of the performed paging procedure.

FIG. 4 also illustrates the RAN node 400 comprising a memory 410. It shall be pointed out that FIG. 4 is merely an exemplifying illustration and memory 410 may be optional, be a part of the memory 422 or be a further memory of the RAN node 400. The memory may for example comprise information relating to the RAN node 400, to statistics of operation of the RAN node 400, just to give a couple of illustrating examples. FIG. 4 further illustrates the RAN node 400 comprising processing means 420, which comprises the memory 422 and the processor 421.

Still further, FIG. 4 illustrates the RAN node 400 comprising a communication unit 430. The communication unit 430 may comprise an interface through which the RAN node 400 communicates with other nodes or entities of the communication network as well as other communication units. FIG. 4 also illustrates the RAN node 400 comprising further functionality 440. The further functionality 440 may comprise hardware or software necessary for the RAN node 400 to perform different tasks that are not disclosed herein.

An alternative exemplifying implementation of the RAN node 400, 500 is illustrated in FIG. 5. FIG. 5 illustrates the RAN node 500 comprising an exchanging unit 503 for exchanging paging strategy information with a Core Network, CN, node. The RAN node 500 further comprises a performing unit 504 for performing a RAN paging procedure of the wireless device according to the exchanged paging strategy information; and an updating unit 505 for updating the paging strategy information based on the outcome of the performed paging procedure.

In FIG. 5, the RAN node 500 is also illustrated comprising a communication unit 501. Through this unit, the RAN node 500 is adapted to communicate with other nodes and/or entities in the wireless communication network. The communication unit 501 may comprise more than one receiving arrangement. For example, the communication unit 501 may be connected to both a wire and an antenna, by means of which RAN node 500 is enabled to communicate with other nodes and/or entities in the wireless communication network. Similarly, the communication unit 501 may comprise more than one transmitting arrangement, which in turn is connected to both a wire and an antenna, by means of which the RAN node 500 is enabled to communicate with other nodes and/or entities in the wireless communication network. The RAN node 500 is further illustrated comprising a memory 502 for storing data. Further, the RAN node 500 may comprise a control or processing unit (not shown) which in turn is connected to the different units 503-505. It shall be pointed out that this is merely an illustrative example and the RAN node 500 may comprise more, less or other units or modules which execute the functions of the RAN node 500 in the same manner as the units illustrated in FIG. 5.

It should be noted that FIG. 5 merely illustrates various functional units in the RAN node 500 in a logical sense. The functions in practice may be implemented using any suitable software and hardware means/circuits etc. Thus, the embodiments are generally not limited to the shown structures of the RAN node 500 and the functional units. Hence, the previously described exemplary embodiments may be realised in many ways. For example, one embodiment includes a computer-readable medium having instructions stored thereon that are executable by the control or processing unit for executing the method steps in the RAN node 500. The instructions executable by the computing system and stored on the computer-readable medium perform the method steps of the RAN node 500 as set forth in the claims.

In an example, the RAN node is configured for updating the paging strategy information by receiving the updated paging strategy information from the CN node.

In another example, the RAN node is configured for updating the paging strategy information by evaluating the outcome of the performed RAN paging procedure.

In yet an example, the exchanging of the paging strategy information is performed by one or more information elements in a message of an Evolved Radio Access Bearer, E-RAB, management procedure, and/or by one or more information elements in a message of a User Equipment, UE, context management procedure; and/or control signalling between the RAN node and the CN node.

In still an example, the RAN node is configured for sending a request to the CN node to perform a first CN paging procedure of the wireless device, when the outcome of the performed RAN paging procedure is a) failure to reach the wireless device, or b) failure to reach the wireless device within a predefined timeframe or c) failure due to other reasons determined by the RAN node.

In a further example, the RAN node being configured for sending the request to the CN node to perform the first CN paging procedure of the wireless device comprises the RAN node being configured for providing the CN node with information pertaining to the performed RAN paging procedure.

In another example, the RAN node is configured for sending a request to the CN node to perform a second CN paging procedure of the wireless device, when the outcome of the performed RAN paging procedure is a) failure to reach the wireless device, or b) failure to reach the wireless device within a predefined timeframe or c) failure due to other reasons determined by the RAN node.

In yet an example, the RAN node being configured for sending the request to the CN node to perform the second CN paging procedure comprises the RAN node being configured for providing the CN node with information pertaining to the performed RAN paging procedure.

In still an example, the RAN node is further configured for evaluating the outcome of the performed RAN paging procedure; for updating the paging strategy information based on the evaluated outcome; and for exchanging paging strategy information with the CN node.

In a further example, the RAN node is configured for evaluating of the outcome of the performed RAN paging procedure by determining whether a paging delay is within a predefined time interval.

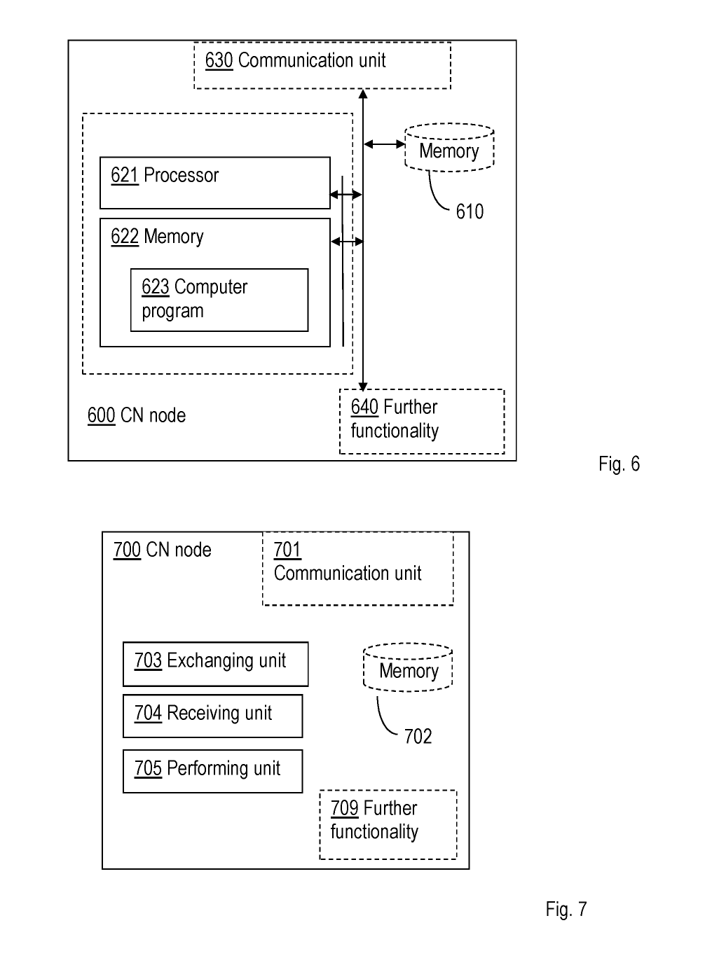

Embodiments herein also relate to a CN node for paging a wireless device in a wireless communication network. Different embodiments and examples of such a CN node will now be described with reference to FIGS. 6 and 7.

FIGS. 6 and 7 illustrate the CN node being configured for exchanging paging strategy information with a Radio Access Network, RAN, node; receiving a request from the RAN node for paging the wireless device; and performing the paging of the wireless device according to the received request.

The CN node may be implemented or realised in different ways. A first exemplifying implementation or realisation is illustrated in FIG. 6. FIG. 6 illustrates the CN node 600 comprising a processor 621 and memory 622, the memory comprising instructions, e.g. by means of a computer program 623, which when executed by the processor 621 causes the CN node 600 to exchange paging strategy information with a RAN node, to receive a request from the RAN node for paging the wireless device; and to perform the paging of the wireless device according to the received request.

FIG. 6 also illustrates the CN node 600 comprising a memory 610. It shall be pointed out that FIG. 6 is merely an exemplifying illustration and memory 610 may be optional, be a part of the memory 622 or be a further memory of the CN node 600. The memory may for example comprise information relating to the CN node 600, to statistics of operation of the CN node 600, just to give a couple of illustrating examples. FIG. 6 further illustrates the CN node 600 comprising processing means 620, which comprises the memory 622 and the processor 621. Still further, FIG. 6 illustrates the CN node 600 comprising a communication unit 630. The communication unit 630 may comprise an interface through which the CN node 600 communicates with other nodes or entities of the communication network as well as other communication units. FIG. 6 also illustrates the CN node 600 comprising further functionality 640. The further functionality 640 may comprise hardware or software necessary for the CN node 600 to perform different tasks that are not disclosed herein.

An alternative exemplifying implementation of the CN node 600, 700 is illustrated in FIG. 7. FIG. 7 illustrates the CN node 700 comprising an exchanging unit 703 for exchanging paging strategy information with a RAN node. CN node 700 further comprises a receiving unit 504 for receiving a request from the RAN node for paging the wireless device; and a performing unit 705 for performing the paging of the wireless device according to the received request.

In FIG. 7, the CN node 700 is also illustrated comprising a communication unit 701. Through this unit, the CN node 700 is adapted to communicate with other nodes and/or entities in the wireless communication network. The communication unit 701 may comprise more than one receiving arrangement. For example, the communication unit 701 may be connected to both a wire and an antenna, by means of which CN node 700 is enabled to communicate with other nodes and/or entities in the wireless communication network. Similarly, the communication unit 701 may comprise more than one transmitting arrangement, which in turn is connected to both a wire and an antenna, by means of which the CN node 700 is enabled to communicate with other nodes and/or entities in the wireless communication network. The CN node 700 is further illustrated comprising a memory 702 for storing data. Further, the CN node 700 may comprise a control or processing unit (not shown) which in turn is connected to the different units 703-705. It shall be pointed out that this is merely an illustrative example and the CN node 700 may comprise more, less or other units or modules which execute the functions of the CN node 700 in the same manner as the units illustrated in FIG. 7.

It should be noted that FIG. 7 merely illustrates various functional units in the CN node 700 in a logical sense. The functions in practice may be implemented using any suitable software and hardware means/circuits etc. Thus, the embodiments are generally not limited to the shown structures of the CN node 700 and the functional units. Hence, the previously described exemplary embodiments may be realised in many ways. For example, one embodiment includes a computer-readable medium having instructions stored thereon that are executable by the control or processing unit for executing the method steps in the CN node 700. The instructions executable by the computing system and stored on the computer-readable medium perform the method steps of the CN node 700 as set forth in the claims.

In an example, wherein the received request from the RAN node for paging the wireless device requests the CN node to take over the paging procedure from the RAN node, the CN node is configured for performing the paging procedure comprises the CN node being configured for applying the paging strategy information to the paging procedure and optionally information comprised in the received request from the RAN node.

In yet an example, the CN node is further configured for evaluating the outcome of the performed paging procedure, updating the paging strategy information based on the evaluated outcome and exchanging paging strategy information with the RAN node, when the outcome of the performed paging procedure is successful in reaching the wireless device.

In still an example, wherein the received request from the RAN node for paging the wireless device requests the CN node to perform a paging attempt, wherein the received request comprises information enabling the CN node to perform the requested paging attempt, the CN node is configured for performing the paging of the wireless device according to the received request and in view of the information comprised in the received request from the RAN node.

In a further example, the CN node is further configured for evaluating the outcome of the performed paging procedure, updating the paging strategy information based on the evaluated outcome and exchanging paging strategy information with the RAN node, when the outcome of the performed paging procedure is successful in reaching the wireless device.

In another example, the CN node is further configured for establishing a UE context in a RAN node.

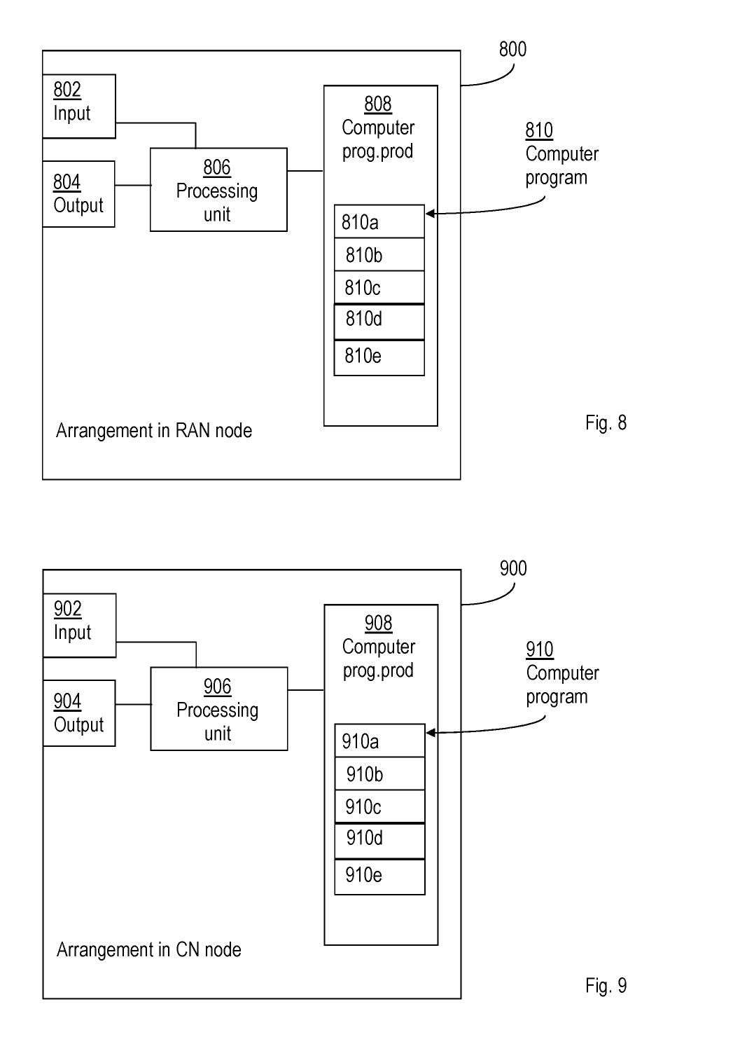

FIG. 8 schematically shows an embodiment of an arrangement 800 in a RAN node 500. Comprised in the arrangement 800 in the RAN node 500 are here a processing unit 806, e.g. with a Digital Signal Processor, DSP. The processing unit 806 may be a single unit or a plurality of units to perform different actions of procedures described herein. The arrangement 800 of the RAN node 500 may also comprise an input unit 802 for receiving signals from other entities, and an output unit 804 for providing signal(s) to other entities. The input unit and the output unit may be arranged as an integrated entity or as illustrated in the example of FIG. 5, as one or more interfaces 501.

Furthermore, the arrangement 800 in the RAN node 500 comprises at least one computer program product 808 in the form of a non-volatile memory, e.g. an Electrically Erasable Programmable Read-Only Memory, EEPROM, a flash memory and a hard drive. The computer program product 808 comprises a computer program 810, which comprises code means, which when executed in the processing unit 806 in the arrangement 800 in the RAN node 500 causes the RAN node to perform the actions e.g. of the procedure described earlier in conjunction with FIGS. 1a-1d.

The computer program 810 may be configured as a computer program code structured in computer program modules 810a-810e. Hence, in an exemplifying embodiment, the code means in the computer program of the arrangement 800 in the RAN node 500 comprises an exchanging unit, or exchanging module, for exchanging paging strategy information with a CN node. The computer program further comprises a performing unit, or performing module, for performing a RAN paging procedure of the wireless device according to the exchanged paging strategy information, and an updating unit, or updating module, for updating the paging strategy information based on the outcome of the performed paging procedure.

The computer program modules could essentially perform the actions of the flow illustrated in FIGS. 1a-1d, to emulate RAN node 500. In other words, when the different computer program modules are executed in the processing unit 806, they may correspond to the units 503-505 of FIG. 5.

FIG. 9 schematically shows an embodiment of an arrangement 900 in a CN node 700. Comprised in the arrangement 900 in the CN node 700 are here a processing unit 906, e.g. with a Digital Signal Processor. The processing unit 906 may be a single unit or a plurality of units to perform different actions of procedures described herein. The arrangement 900 in the CN node 700 may also comprise an input unit 902 for receiving signals from other entities, and an output unit 904 for providing signal(s) to other entities. The input unit and the output unit may be arranged as an integrated entity or as illustrated in the example of FIG. 7, as one or more interfaces 701.

Furthermore, the arrangement 900 in the CN node 700 comprises at least one computer program product 908 in the form of a non-volatile memory, e.g. an Electrically Erasable Programmable Read-Only Memory, EEPROM, a flash memory and a hard drive. The computer program product 908 comprises a computer program 910, which comprises code means, which when executed in the processing unit 906 in the CN node 700 causes the CN node 700 to perform the actions e.g. of the procedure described earlier in conjunction with FIGS. 2a-2c.

The computer program 910 may be configured as a computer program code structured in computer program modules 910a-910e. Hence, in an exemplifying embodiment, the code means in the computer program of the CN node 700 comprises an exchanging unit, or module, for exchanging paging strategy information with a Radio Access Network, RAN, node. The computer program further comprises a receiving unit, or module, for receiving a request from the RAN node for paging the wireless device; and a performing unit, or module, for performing the paging of the wireless device according to the received request.

The computer program modules could essentially perform the actions of the flow illustrated in FIGS. 2a-2c, to emulate the RAN node 700. In other words, when the different computer program modules are executed in the processing unit 906, they may correspond to the units 703-705 of FIG. 7.

Although the code means in the respective embodiments disclosed above in conjunction with FIGS. 5 and 7 are implemented as computer program modules which when executed in the respective processing unit causes the RAN node and the CN node respectively to perform the actions described above in the conjunction with figures mentioned above, at least one of the code means may in alternative embodiments be implemented at least partly as hardware circuits.

The processor may be a single Central Processing Unit, CPU, but could also comprise two or more processing units. For example, the processor may include general purpose microprocessors; instruction set processors and/or related chips sets and/or special purpose microprocessors such as Application Specific Integrated Circuits, ASICs. The processor may also comprise board memory for caching purposes. The computer program may be carried by a computer program product connected to the processor. The computer program product may comprise a computer readable medium on which the computer program is stored. For example, the computer program product may be a flash memory, a Random-Access Memory RAM, Read-Only Memory, ROM, or an EEPROM, and the computer program modules described above could in alternative embodiments be distributed on different computer program products in the form of memories within the RAN node and the CN node respectively.

It is to be understood that the choice of interacting units, as well as the naming of the units within this disclosure are only for exemplifying purpose, and nodes suitable to execute any of the methods described above may be configured in a plurality of alternative ways in order to be able to execute the suggested procedure actions.

It should also be noted that the units described in this disclosure are to be regarded as logical entities and not with necessity as separate physical entities.

While the embodiments have been described in terms of several embodiments, it is contemplated that alternatives, modifications, permutations and equivalents thereof will become apparent upon reading of the specifications and study of the drawings. It is therefore intended that the following appended claims include such alternatives, modifications, permutations and equivalents as fall within the scope of the embodiments and defined by the pending claims.

1. A method (100) performed by a Radio Access Network, RAN, node for paging a wireless device in a wireless communication network, the method comprising:
exchanging (110) paging strategy information with a Core Network, CN, node,
performing (120) a RAN paging procedure of the wireless device according to the exchanged paging strategy information, and
updating (180) the paging strategy information based on the outcome of the performed RAN paging procedure.

2. The method (100) according to claim 1, wherein the updating (180) of the paging strategy information comprises receiving the updated paging strategy information from the CN node.

3. The method (100) according to claim 1 or 2, wherein the updating (180) of the paging strategy information comprises evaluating the outcome of the performed RAN paging procedure.

4. The method (100) according to any of claims 1-3, wherein the exchanging (110) of the paging strategy information is performed by one or more information elements in a message of an Evolved Radio Access Bearer, E-RAB, management procedure, and/or by one or more information elements in a message of a User Equipment, UE, context management procedure; and/or control signalling between the RAN node and the CN node.

5. The method (100) according to any of claims 1-4, when the outcome of the performed RAN paging procedure is a) failure to reach the wireless device, or b) failure to reach the wireless device within a predefined timeframe or c) failure due to other reasons determined by the RAN node, the method (100) comprises sending a request (130) to the CN node to perform a first CN paging procedure of the wireless device.

6. The method (100) according to claim 5, wherein the sending the request (130) to the CN node to perform the first CN paging procedure of the wireless device comprises providing the CN node with information pertaining to the performed RAN paging procedure.

7. The method (100) according to any of claims 1-6, when the outcome of the performed RAN paging procedure is a) failure to reach the wireless device, or b) failure to reach the wireless device within a predefined timeframe or c) failure due to other reasons determined by the RAN node, the method (100) comprises sending a request (140) to the CN node to perform a second CN paging procedure.

8. The method (100) according to claim 7, wherein the sending the request (140) to the CN node to perform the second CN paging procedure comprises providing the CN node with information pertaining to the performed RAN paging procedure.

9. The method (100) according to any of claims 1-8, the method (100) further comprises evaluating (150) the outcome of the performed RAN paging procedure, updating (180) the paging strategy information based on the evaluated outcome and exchanging (110) paging strategy information with the CN node.

10. The method (100) according to claim 9, the evaluating of the outcome of the performed RAN paging procedure comprises determining whether a paging delay is within a predefined time interval.

11. A method (200) performed by a Core Network, CN, node for paging a wireless device in a wireless communication network, the method (200) comprising:
exchanging (210) paging strategy information with a Radio Access Network, RAN, node,
receiving (220) a request from the RAN node for paging the wireless device,
performing (230) the paging of the wireless device according to the received request.

12. The method (200) according to claim 11, wherein the received request from the RAN node for paging the wireless device requests the CN node to take over the paging procedure from the RAN node, wherein the performing (230) of the paging procedure comprises applying the paging strategy information to the paging procedure and optionally information comprised in the received request from the RAN node.

13. The method (200) according to claim 11 or 12, when the outcome of the performed paging procedure is successful in reaching the wireless device, the method (200) further comprises evaluating (240) the outcome of the performed paging procedure, updating (250) the paging strategy information based on the evaluated outcome and exchanging (210) paging strategy information with the RAN node.

14. The method (200) according to claim 11, wherein the received request from the RAN node for paging the wireless device requests the CN node to perform a paging attempt, wherein the received request comprises information enabling the CN node to perform the requested paging attempt, the performing (230) of the paging of the wireless device is performed according to the received request and in view of the information comprised in the received request from the RAN node.

15. The method (200) according to claim 11 or 14, when the outcome of the performed paging procedure is successful in reaching the wireless device, the method (200) further comprises evaluating (240) the outcome of the performed paging procedure, updating (250) the paging strategy information based on the evaluated outcome and exchanging (210) paging strategy information with the RAN node.

16. The method (200) according to any of claims 11-15, wherein the method (200) further comprises establishing (260) a UE context in a RAN node.

17. A Radio Access Network, RAN, node (400, 500) for paging a wireless device in a wireless communication network, the RAN node (400, 500) being configured for:
exchanging paging strategy information with a Core Network, CN, node,
performing a RAN paging procedure of the wireless device according to the exchanged paging strategy information, and
updating the paging strategy information based on the outcome of the performed RAN paging procedure.

18. The RAN node (400, 500) according to claim 17, being configured for updating the paging strategy information by receiving the updated paging strategy information from the CN node.

19. The RAN node (400, 500) according to claim 17 or 18, being configured for updating the paging strategy information by evaluating the outcome of the performed RAN paging procedure.

20. The RAN node (400, 500) according to any of claims 17-19, wherein the exchanging of the paging strategy information is performed by one or more information elements in a message of an Evolved Radio Access Bearer, E-RAB, management procedure, and/or by one or more information elements in a message of a User Equipment, UE, context management procedure; and/or control signalling between the RAN node and the CN node.

21. The RAN node (400, 500) according to any of claims 17-20, when the outcome of the performed RAN paging procedure is a) failure to reach the wireless device, or b) failure to reach the wireless device within a predefined timeframe or c) failure due to other reasons determined by the RAN node, the RAN node (400, 500) is configured for sending a request to the CN node to perform a first CN paging procedure of the wireless device.

22. The RAN node (400, 500) according to claim 21, wherein the sending of the request to the CN node to perform the first CN paging procedure of the wireless device comprises providing the CN node with information pertaining to the performed RAN paging procedure.

23. The RAN node (400, 500) according to any of claims 17-22, when the outcome of the performed RAN paging procedure is a) failure to reach the wireless device, or b) failure to reach the wireless device within a predefined timeframe or c) failure due to other reasons determined by the RAN node, the RAN node (400, 500) is configured for sending a request to the CN node to perform a second CN paging procedure.

24. The RAN node (400, 500) according to claim 23, wherein the sending of the request to the CN node to perform the second CN paging procedure comprises providing the CN node with information pertaining to the performed RAN paging procedure.

25. The RAN node (400, 500) according to any of claims 17-24, the RAN node (400, 500) further being configured for evaluating the outcome of the performed RAN paging procedure, updating the paging strategy information based on the evaluated outcome and exchanging paging strategy information with the CN node.

26. The RAN node (400, 500) according to claim 25, wherein the RAN node (400, 500) is configured for evaluating of the outcome of the performed RAN paging procedure by determining whether a paging delay is within a predefined time interval.

27. A Core Network, CN, node (600, 700) for paging a wireless device in a wireless communication network, the CN node (600, 700) being configured for:
exchanging paging strategy information with a Radio Access Network, RAN, node,
receiving a request from the RAN node for paging the wireless device, and
performing the paging of the wireless device according to the received request.

28. The CN node (600, 700) according to claim 27, wherein the received request from the RAN node for paging the wireless device requests the CN node to take over the paging procedure from the RAN node, wherein the performing of the paging procedure comprises the CN node (600, 700) being configured for applying the paging strategy information to the paging procedure and optionally information comprised in the received request from the RAN node.

29. The CN node (600, 700) according to claim 27 or 28, when the outcome of the performed paging procedure is successful in reaching the wireless device, the CN node (600, 700) further being configured for evaluating the outcome of the performed paging procedure, updating the paging strategy information based on the evaluated outcome and exchanging paging strategy information with the RAN node.

30. The CN node (600, 700) according to claim 27, wherein the received request from the RAN node for paging the wireless device requests the CN node to perform a paging attempt, wherein the received request comprises information enabling the CN node to perform the requested paging attempt, the CN node (600, 700) being configured for performing of the paging of the wireless device according to the received request and in view of the information comprised in the received request from the RAN node.

31. The CN node (600, 700) according to claim 27 or 30, when the outcome of the performed paging procedure is successful in reaching the wireless device, the CN node (600, 700) is further configured for evaluating the outcome of the performed paging procedure, updating the paging strategy information based on the evaluated outcome and exchanging paging strategy information with the RAN node.

32. The CN node (600, 700) according to any of claims 27-31, further being configured for establishing a UE context in a RAN node.

33. A Computer program (810), comprising computer readable code means, which when run in a processing unit (806) comprised in an arrangement (800) in Radio Access Network, RAN, node (500) according to claims 17-26 causes the RAN node (500) to perform the corresponding method according to any of claims 1-10.

34. A Computer program product (808) comprising the computer program (810) according to claim 33.

35. A Computer program (910), comprising computer readable code means, which when run in a processing unit (906) comprised in an arrangement (900) in a Core Network, CN, node (700) according to claims 27-32 causes the CN node (700) to perform the corresponding method according to any of claims 11-16.

36. A Computer program product (908) comprising the computer program (910) according to claim 34.
